(19) United States
(12) Patent Application Publication
(10) Pub. No.: US 2008/0053391 A1
(43) Pub. Date: Mar. 6, 2008

(54) Air-intake apparatus

(75) Inventor: Kazuhiro Hayashi, Nishikamo-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/826,429

(22) Filed: Jul. 16, 2007

(30) Foreign Application Priority Data
Aug. 29, 2006 (JP) 2006-232112

(51) Int. Cl. F02M 35/104

(52) U.S. Cl. 123/184.21

(57) ABSTRACT

An air-intake apparatus includes a surge tank, a plurality of intake manifolds, a throttle, and a connecting pipe portion. A plurality of cylinders of an internal combustion engine includes a predetermined group of cylinders, a phase difference in combustion timing between which is an integral multiple of a combustion interval between the plurality of cylinders. The integral multiple is equal to or larger than two times. The plurality of intake manifolds includes a group of intake manifolds, each of which is connected to corresponding one of the predetermined group of cylinders. The connecting pipe portion connects the group of intake manifolds.

### CROSS REFERENCE TO RELATED APPLICATION

This application is based on and incorporates herein by reference Japanese Patent Application No. 2006-232112 filed on Aug. 29, 2006.

### BACKGROUND OF THE INVENTION

1. Field of the Invention

The present invention relates to an air-intake apparatus of an internal combustion engine.

2. Description of Related Art

An air-intake apparatus supplies air, which is taken in, to an internal combustion engine. Air that is taken in is distributed to each cylinder of the internal combustion engine through intake manifolds branching from a surge tank. An air-intake apparatus having a compound throttle, each throttle of which is disposed in corresponding one of the intake manifolds, is known. In the air-intake apparatus having the compound throttle, a connecting pipe portion that connects the intake manifolds is provided to reduce variation of an intake air flow among the intake manifolds (see JP63-154827A).

Air in the intake manifold is drawn to a cylinder side while an inlet valve is opened. Thus, pressure of air is lower than an atmospheric pressure in an end portion of the intake manifold on the cylinder side while the inlet valve is opened. In an internal combustion engine having a plurality of cylinders, at least one of inlet valves is opened. Accordingly, when the intake manifolds are connected through the connecting pipe portion in JP63-154827A, the pressure of air in an end portion of one of the intake manifolds on the cylinder side is constantly lower than the atmospheric pressure.

On the other hand, pressure in a corresponding cylinder is approximately the atmospheric pressure shortly before the inlet valve is opened. Therefore, when the inlet valve is opened, suction force is generated from the cylinder side to an intake manifold side. As a result, pumping loss, which means that intake air is prevented from flowing into the cylinder from the intake manifold, is caused. Accordingly, a filling efficiency of each cylinder with intake air is decreased, thereby causing poor mileage of the internal combustion engine.

### SUMMARY OF THE INVENTION

The present invention addresses the above disadvantages. Thus, it is an objective of the present invention to provide an air-intake apparatus, whereby pumping loss is reduced as well as variation of a flow of air among intake manifolds being reduced.

To achieve the objective of the present invention, there is provided an air-intake apparatus for an internal combustion engine having a plurality of cylinders. The air-intake apparatus includes a surge tank, a plurality of intake manifolds, a throttle that includes a plurality of valve members, and a connecting pipe portion. Each of the plurality of intake manifolds connects the surge tank and corresponding one of the plurality of cylinders. The plurality of cylinders includes a predetermined group of cylinders, a phase difference in combustion timing between which is an integral multiple of a combustion interval between the plurality of cylinders of the internal combustion engine. The integral multiple is equal to or larger than two times. The plurality of intake manifolds includes a group of intake manifolds, each of which is connected to corresponding one of the predetermined group of cylinders. Each of the plurality of valve members is disposed in corresponding one of the plurality of intake manifolds to open or close an air flowing passage in the corresponding one of the plurality of intake manifolds. The connecting pipe portion is located between the internal combustion engine and the throttle. The connecting pipe portion connects the group of intake manifolds.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view showing a serially-arranged four-cylinder gasoline engine, to which an air-intake apparatus of the present invention is applied according to a first embodiment of the present invention;

FIG. 2 is a schematic view showing a configuration of air flowing passages of the air-intake apparatus in FIG. 1 according to the first embodiment;

FIG. 3A is a schematic view showing a configuration of passages of the air-intake apparatus, which is applied to a serially-arranged six-cylinder gasoline engine, according to a second embodiment of the present invention;

FIG. 3B is a schematic view showing another configuration of the passages of the air-intake apparatus, which is applied to the serially-arranged six-cylinder gasoline engine, according to the second embodiment;

FIG. 4A is a schematic view showing a configuration of passages of the air-intake apparatus, which is applied to a V-six gasoline engine, according to a third embodiment of the present invention;

FIG. 4B is a schematic view showing another configuration of the passages of the air-intake apparatus, which is applied to the V-six gasoline engine, according to the third embodiment;

FIG. 5A is a schematic view showing a configuration of passages of the air-intake apparatus, which is applied to a serially-arranged eight-cylinder gasoline engine, according to a fourth embodiment of the present invention;

FIG. 5B is a schematic view showing another configuration of the passages of the air-intake apparatus, which is applied to the serially-arranged eight-cylinder gasoline engine, according to the fourth embodiment;

FIG. 6A is a schematic view showing a configuration of passages of the air-intake apparatus, which is applied to a V-eight gasoline engine, according to a fifth embodiment of the present invention;

FIG. 6B is a schematic view showing another configuration of the passages of the air-intake apparatus, which is applied to the V-eight gasoline engine, according to the fifth embodiment;

FIG. 7A is a schematic view showing a first configuration of passages of the air-intake apparatus, which is applied to a serially-arranged five-cylinder gasoline engine, according to a sixth embodiment of the present invention;

FIG. 7B is a schematic view showing a second configuration of the passages of the air-intake apparatus, which is applied to the serially-arranged five-cylinder gasoline engine, according to the sixth embodiment;

FIG. 7C is a schematic view showing a third configuration of the passages of the air-intake apparatus, which is applied to the serially-arranged five-cylinder gasoline engine, according to the sixth embodiment;

FIG. 7D is a schematic view showing a fourth configuration of the passages of the air-intake apparatus, which is applied to the serially-arranged five-cylinder gasoline engine, according to the sixth embodiment;

FIG. 7E is a schematic view showing a fifth configuration of the passages of the air-intake apparatus, which is applied to the serially-arranged five-cylinder gasoline engine, according to the sixth embodiment;

FIG. 8A is a schematic view showing a configuration of passages of the air-intake apparatus, which is applied to a V-ten gasoline engine, according to a seventh embodiment of the present invention;

FIG. 8B is a schematic view showing another configuration of the passages of the air-intake apparatus, which is applied to the V-ten gasoline engine, according to the seventh embodiment;

FIG. 9A is a graph showing a relationship between a rotation angle of a crankshaft and a pressure in an intake manifold, and a relationship between the rotation angle and a valve opening/closing amount of an inlet valve, in a gasoline engine to which the air-intake apparatus is applied, according to the first embodiment; and

FIG. 9B is a graph showing a relationship between the rotation angle of the crankshaft and the pressure in the intake manifold, and a relationship between the rotation angle and the valve opening/closing amount of the inlet valve, in a comparative example.

### DETAILED DESCRIPTION OF THE INVENTION

Air-intake apparatuses according to embodiments of the present invention will be described below with reference to drawings. In the embodiments below, the same numerals are used to indicate substantially the same components to simplify the description.

### First Embodiment

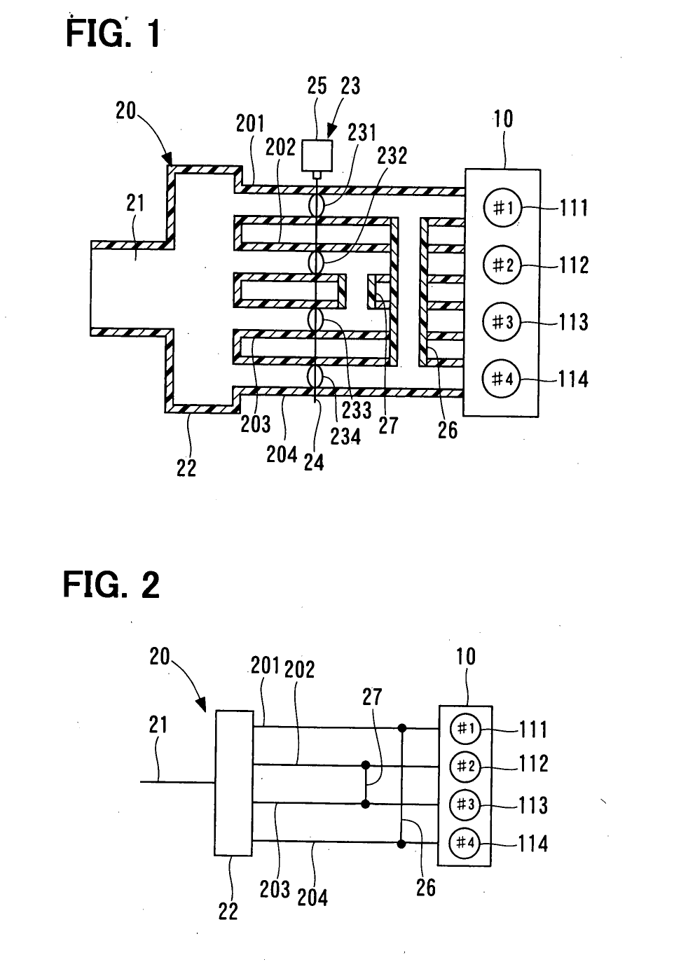

FIGS. 1, 2 show a gasoline engine as an internal combustion engine, employing an air-intake apparatus according to a first embodiment of the present invention. In FIGS. 1, 2, an example is shown, in which the air-intake apparatus according to the first embodiment is applied to a four-cylinder gasoline engine 10. FIG. 1 is a schematic partial cross sectional view of the gasoline engine 10, to which the air-intake apparatus according to the first embodiment is applied. FIG. 2 is a schematic view showing a configuration of passages, through which air to be drawn into the gasoline engine 10 in FIG. 1 flows.

An air-intake apparatus 20 is installed in the gasoline engine 10. The gasoline engine 10 has four cylinders. The four cylinders are arranged such that a first cylinder (#1) 111, a second cylinder (#2) 112, a third cylinder (#3) 113, and a fourth cylinder (#4) 114 are placed in this order from before backward in a traveling direction of a vehicle in which the gasoline engine 10 is installed. Each of the cylinders has a piston (not shown).

The air-intake apparatus 20 has an intake passage 21, a surge tank 22, and four intake manifolds 201, 202, 203, 204. The intake passage 21, the surge tank 22, and the intake manifolds 201, 202, 203, 204 may be integrally formed from, for example, a passage forming member made of resin. An end portion of the intake passage 21 on an opposite side from the surge tank 22 is connected to an air cleaner (not shown). A foreign object, which is included in air drawn into the air-intake apparatus 20, is removed in the air cleaner. Air that passes through the air cleaner flows into the surge tank 22 via the intake passage 21.

The surge tank 22 is connected to the other end portion of the intake passage 21, which is on an opposite side from the air cleaner. The surge tank 22 branches into the intake manifolds 201, 202, 203, 204. Air, which flows into the intake passage 21 through the air cleaner, flows into the surge tank 22, and is distributed to each of the intake manifolds 201, 202, 203, 204. The intake manifold 201 connects the surge tank 22 and the first cylinder 111. The intake manifold 202 connects the surge tank 22 and the second cylinder 112. The intake manifold 203 connects the surge tank 22 and the third cylinder 113. The intake manifold 204 connects the surge tank 22 and the fourth cylinder 114. Each of the intake manifolds 201, 202, 203, 204 has an air passage, through which air to be supplied to the gasoline engine 10 by the surge tank 22 flows, on its inner circumferential side.

The air-intake apparatus 20 has a throttle 23. The throttle 23 has throttle valves 231, 232, 233, 234 as valve members, a drive shaft 24, and an actuator 25. Each of the throttle valves 231, 232, 233, 234 is disposed in the corresponding intake manifold. The drive shaft 24 is assembled integrally with the throttle valves 231, 232, 233, 234. The actuator 25 drives the drive shaft 24 to rotate in its circumferential direction. Accordingly, the throttle valves 231, 232, 233, 234 are driven to rotate together by the drive shaft 24. As a result, the air passages formed in the intake manifolds 201, 202, 203, 204 are opened or closed by the throttle valves 231, 232, 233, 234, respectively. Thus, a flow of air that flows through each of the air passages is regulated. In addition, the gasoline engine 10 has an inlet valve (not shown). The inlet valve opens or closes inflows of air from each of the intake manifolds 201, 202, 203, 204 to corresponding one of the cylinders 111,112,113,114.

In the first embodiment, the air-intake apparatus 20 has two connecting pipe portions 26, 27 on a gasoline engine 10-side of the throttle 23. The connecting pipe portion 26 connects the air passage formed in the intake manifold 201 connected to the first cylinder 111 and the air passage formed in the intake manifold 204 connected to the fourth cylinder 114. The connecting pipe portion 27 connects the air passage formed in the intake manifold 202 connected to the second cylinder 112 and the air passage formed in the intake manifold 203 connected to the third cylinder 113.

The gasoline engine 10 has an ignition coil (not shown). The ignition coil is disposed in each of the cylinders 111,112,113,114. The ignition coil ignites mixed gas compressed in each of the cylinders 111,112,113,114. In the case of the four-cylinder gasoline engine 10 in the first embodiment, mixed gas is combusted in the first cylinder 111, the third cylinder 113, the fourth cylinder 114, and the second cylinder 112 in this order. Thus, in the gasoline engine 10, the ignition coil in the first cylinder 111, the ignition coil in the third cylinder 113, the ignition coil in the fourth cylinder 114, and the ignition coil in the second cylinder. 112 are energized in this order. Hence, in the case of the gasoline engine 10, combustion timing in each of the cylinders 111,112,113,114 is synonymous with ignition timing. Description will be provided below by referring to the combustion timing in each of the cylinders 111,112,113,114 of the gasoline engine 10 as the ignition timing.

In the case of the four-cylinder gasoline engine 10 as described above, a combustion interval, that is, an ignition interval between the four cylinders 111,112,113,114 is 90°. In the four-cylinder gasoline engine 10, mixed gas is ignited in the first cylinder 111, the third cylinder 113, the fourth cylinder 114, and the second cylinder 112 in this order. Accordingly, between the first cylinder 111 and the fourth cylinder 114, and between the second cylinder 112 and the third cylinder 113, a phase difference in the combustion timing, that is, a phase difference in the ignition timing is 180°. Thus, between the first cylinder. 111 and the fourth cylinder 114, and between the second cylinder 112 and the third cylinder 113, the phase difference in the ignition timing is twice as large as the ignition interval.

Also, the ignition timing in the third cylinder 113 is set between the ignition timing in the first cylinder 111 and the ignition timing in the fourth cylinder 114. The ignition timing in the fourth cylinder 114 is set between the ignition timing in the second cylinder 112 and the ignition timing in the third cylinder 113. In this manner, mixed gas is ignited in the first cylinder 111 and the fourth cylinder 114 every other ignition timing, and mixed gas is ignited in the second cylinder 112 and the third cylinder 113 every other ignition timing.

In the case of the four-cylinder gasoline engine 10 of the first embodiment as described above, the connecting pipe portion 26 connects the intake manifold 201 connected to the first cylinder 111 and the intake manifold 204 connected to the fourth cylinder 114, mixed gas being ignited every other ignition timing in the cylinders 111,114, and the phase difference in the ignition timing between the cylinders 111,114 being twice as large as the ignition interval. The connecting pipe portion 27 connects the intake manifold 202 connected to the second cylinder 112 and the intake manifold 203 connected to the third cylinder 113, mixed gas being ignited every other ignition timing in the cylinders 112,113, and the phase difference in the ignition timing between the cylinders 112,113 being twice as large as the ignition interval.

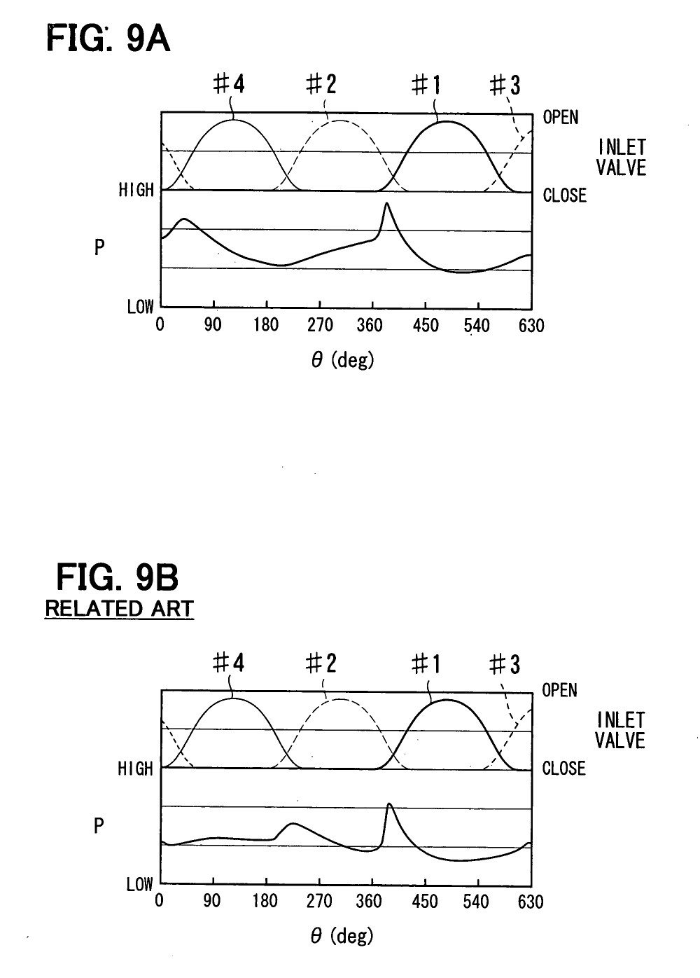

FIG. 9A is a graph showing a relationship between a rotation angle (θ), that is, a rotation angle of a crankshaft, and a valve opening amount of the inlet valve for each cylinder, and a relationship between the rotation angle and a pressure (P) at an end portion of the intake manifold 201 on a first cylinder 111-side.

By providing the connecting pipe portion 26, the pressure at the end portion of the intake manifold 201 on the first cylinder 111-side increases before the inlet valve of the first cylinder 111 opens, as shown in FIG. 9A. The pressure at the end portion of the intake manifold 201 on the first cylinder 111-side returns to around atmospheric pressure. That is, when the rotation angle is increased from 180° to 360°, the pressure at the end portion of the intake manifold 201 on the first cylinder 111-side increases. This is because intake air is supplied from the intake passage 21 and the air-intake apparatus 20, which are at the atmospheric pressure, through the throttle valve 231, and the throttle valve 234 via the connecting pipe portion 26. As a result, when the inlet valve of the first cylinder 111 opens, a pressure inside the first cylinder 111 approximates the pressure at the end portion of the intake manifold 201 on the first cylinder 111-side. Accordingly, air is rapidly drawn through the intake manifold 201 into the first cylinder 111, thereby reducing pumping loss. As well, when the inlet valve of the fourth cylinder 114 opens, air is rapidly drawn through the intake manifold 204 into the fourth cylinder 114, thereby reducing pumping loss. Furthermore, by providing the connecting pipe portion 27, air is supplied complementarily to the second cylinder 112 and the third cylinder 113, and thereby pumping loss is reduced.

Moreover, by providing the connecting pipe portion 26, variation of the flow of air is reduced between the intake manifold 201 connected to the first cylinder 111 and the intake manifold 204 connected to the fourth cylinder 114. As well, by providing the connecting pipe portion 27, the variation of the flow of air is reduced between the intake manifold 202 connected to the second cylinder 112 and the intake manifold 203 connected to the third cylinder 113. The variation of the flow of air is reduced between the intake manifolds because, even when the inlet valve is opened in one of the intake manifolds that are connected, air is supplied through the connecting pipe portion from the other intake manifold connected to the cylinder that has a different ignition timing.

On the other hand, as shown in FIG. 9B, when all the intake manifolds 201, 202, 203, 204 are connected by a single connecting pipe portion for the purpose of comparison, the pressure at the end portion of the intake manifold 201 on the first cylinder 111-side decreases when the rotation angle is increased from 180° to 360°. This is because the inlet valve of the second cylinder 112 is opened before the inlet valve of the first cylinder 111 opens. That is, because a pressure in the intake manifold 202 connected to the second cylinder 112 decreases, a pressure in the intake manifold 201 connected to the first cylinder 111 decreases as well through the connecting pipe portion that connects all the intake manifolds. As a result, when the inlet valve of the first cylinder 111 opens, the pressure at the end portion of the intake manifold 201 on the first cylinder 111-side is low, and thereby air flows back from the first cylinder 111 to an intake manifold 201-side. Thus, pumping loss is generated.

As described above, in the first embodiment, the connecting pipe portion 26 connects the intake manifold 201 connected to the first cylinder 111 and the intake manifold 204 connected to the fourth cylinder 114. As well, the connecting pipe portion 27 connects the intake manifold 202 connected to the second cylinder 112 and the intake manifold 203 connected to the third cylinder 113. Accordingly, air is supplied complementarily to the intake manifold 201 and the intake manifold 204, which are connected by the connecting pipe portion 26, and complementarily to the intake manifold 202 and the intake manifold 203, which are connected by the connecting pipe portion 27. Thus, the variation of the flow of air is reduced, and a pressure in an intake manifold connected to one cylinder increases before the inlet valve of the one cylinder opens. As a result, when the inlet valve opens, a backflow of air from the cylinder to an intake manifold-side is reduced. Thus, pumping loss is reduced as well as the variation of the flow of air being reduced.

### Second Embodiment

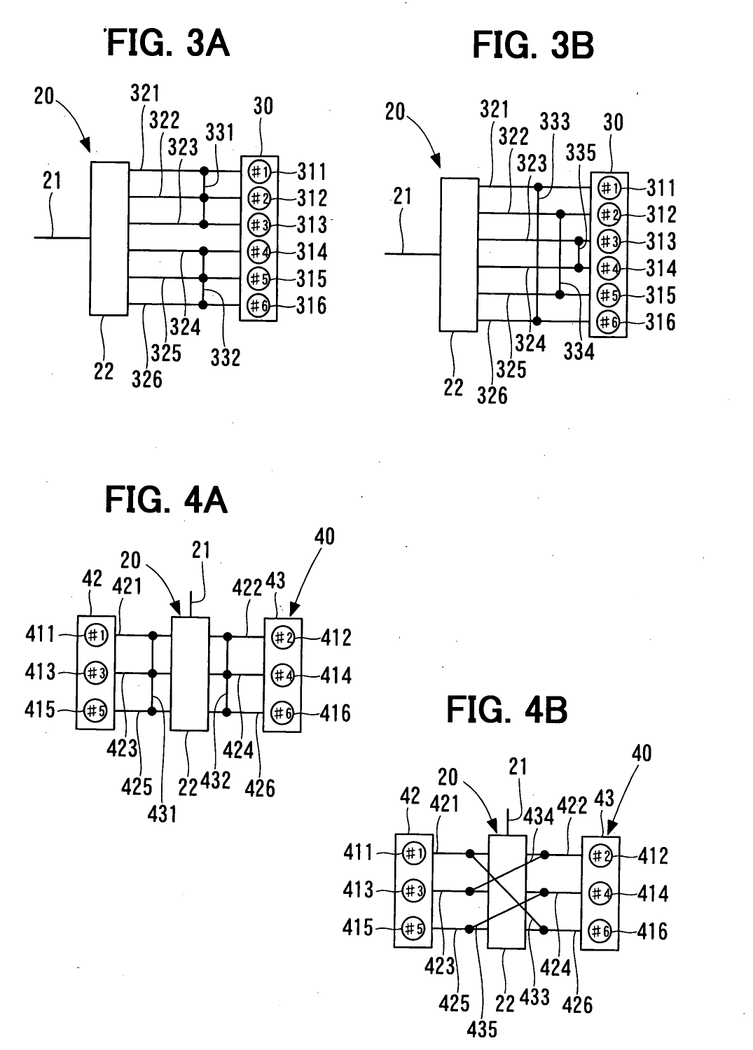

FIGS. 3A, 3B show a gasoline engine, in which an air-intake apparatus according to a second embodiment of the present invention is employed. A gasoline engine 30 shown in FIGS. 3A, 3B has serially-arranged six cylinders. The serially-arranged six-cylinder gasoline engine 30 has six cylinders, that is, a first cylinder 311, a second cylinder 312, a third cylinder 313, a fourth cylinder 314, a fifth cylinder 315, and a sixth cylinder 316 in this order from before backward in a traveling direction of a vehicle. Intake manifolds 321, 322, 323, 324, 325, 326 corresponding to each cylinder connect a surge tank 22 and the gasoline engine 30. In the case of the serially-arranged six-cylinder gasoline engine 30, mixed gas is combusted in, that is, mixed gas is ignited in the first cylinder 311, the fifth cylinder 315, the third cylinder 313, the sixth cylinder 316, the second cylinder 312, and the fourth cylinder 314 in this order. A combustion interval, that is, an ignition interval between the six cylinders is 60°.

In the case of the above serially-arranged six-cylinder gasoline engine 30, although pumping loss is reduced as well as the variation of the flow of air being reduced by providing connecting pipe portions 331, 332, 333, 334, 335 as shown in FIGS. 3A, 3B, one of these two needs to be prioritized over the other according to a manner in which the connecting pipe portions 331, 332, 333, 334, 335 are connected. That is, the manner in which the connecting pipe portions are connected needs to be selected by prioritizing the reduction in the variation of the flow of air or the reduction in pumping loss. Accordingly, when the reduction in the variation of the flow of air is prioritized, reduction performance of pumping loss is lower than when the reduction in pumping loss is prioritized. When the reduction in pumping loss is prioritized, reduction performance of the variation of the flow of air is lower than when the reduction in the variation of the flow of air is prioritized.

When the reduction in the variation of the flow of air is prioritized, as shown in FIG. 3A, the connecting pipe portion 331 connects the intake manifold 321 connected to the first cylinder 311, the intake manifold 322 connected to the second cylinder 312, and the intake manifold 323 connected to the third cylinder 313. Also, the connecting pipe portion 332 connects the intake manifold 324 connected to the fourth cylinder 314, the intake manifold 325 connected to the fifth cylinder 315, and the intake manifold 326 connected to the sixth cylinder 316.

As described above, in the case of the serially-arranged six-cylinder gasoline engine 30, mixed gas is ignited in the first cylinder 311, the fifth cylinder 315, the third cylinder 313, the sixth cylinder 316, the second cylinder 312, and the fourth cylinder 314 in this order. Thus, the connecting pipe portion 331 and the connecting pipe portion 332 connect the intake manifolds that are connected to the cylinders, in which mixed gas is ignited every other ignition timing.

By connecting the intake manifolds that are connected to the cylinders, in which mixed gas is ignited every other ignition timing, through the connecting pipe portion 331 and the connecting pipe portion 332, the variation of the flow of air is reduced in the intake manifolds connected by the connecting pipe portion 331 or the connecting pipe portion 332. The ignition interval between the cylinders, in which mixed gas is ignited every other ignition timing, is 120°, which is twice as large as 60°, that is, the ignition interval of the serially-arranged six-cylinder gasoline engine 30.

When the reduction in pumping loss is prioritized, as shown in FIG. 3B, the connecting pipe portion 333 connects the intake manifold 321 connected to the first cylinder 311 and the intake manifold 326 connected to the sixth cylinder 316. The connecting pipe portion 334 connects the intake manifold 322 connected to the second cylinder 312 and the intake manifold 325 connected to the fifth cylinder 315. The connecting pipe portion 335 connects the intake manifold 323 connected to the third cylinder 313 and the intake manifold 324 connected to the fourth cylinder 314. The ignition interval, that is, the phase difference in the ignition timing between the first cylinder 311 and the sixth cylinder 316, between the second cylinder 312 and the fifth cylinder 315, and between the third cylinder 313 and the fourth cylinder 314, is 180°. Therefore, the phase difference in the ignition timing is 180°, which is three times as large as 60°, that is, the ignition interval of the serially-arranged six-cylinder gasoline engine 30.

By connecting the intake manifolds that are connected to the cylinders, between which the phase difference in the ignition timing is 180°, through the connecting pipe portions 333, 334, 335, air is supplied through the connecting pipe portions 333, 334, 335 from the intake manifold connected to one cylinder before the inlet valve of the other cylinder opens. Accordingly, a pressure in the intake manifold increases to around the atmospheric pressure before the inlet valve opens. As a result, pumping loss is reduced.

### Third Embodiment

FIGS. 4A, 4B show a gasoline engine, in which an air-intake apparatus according to a third embodiment of the present invention is employed. A gasoline engine 40 shown in FIGS. 4A, 4B is a V-six engine. The V-six gasoline engine 40 has a bank block 42 and a bank block 43. The bank block 42 has three cylinders, that is, a first cylinder 411, a third cylinder 413, and a fifth cylinder 415 in this order from before backward in a traveling direction of a vehicle. The bank block 43 has three cylinders, that is, a second cylinder 412, a fourth cylinder 414, and a sixth cylinder 416 in this order from before backward in the traveling direction of the vehicle.

A surge tank 22 is deposed between the bank block 42 and the bank block 43 of the gasoline engine 40. The surge tank 22 may be disposed independently corresponding to the bank block 42 and the bank block 43. Intake manifolds 421, 422, 423, 424, 425, 426 connect the surge tank 22 and the bank block 42, and the surge tank 22 and the bank block 43 corresponding to each cylinder. In the case of the V-six gasoline engine 40, mixed gas is combusted in, that is, mixed gas is ignited in the first cylinder 411, the second cylinder 412, the fifth cylinder 415, the sixth cylinder 416, the third cylinder 413, and the fourth cylinder 414 in this order. A combustion interval, that is, an ignition interval between the six cylinders is 60°

In the case of the above V-six gasoline engine 40, similar to the serially-arranged six-cylinder gasoline engine 30 of the second embodiment, one of the reduction in pumping loss and the reduction in the variation of the flow of air is prioritized over the other according to a manner in which connecting pipe portions 431, 432, 433, 434, 435 are connected.

When the reduction in the variation of the flow of air is prioritized, as shown in FIG. 4A, the connecting pipe portion 431 connects the intake manifold 421 connected to the first cylinder 411, the intake manifold 423 connected to the third cylinder 413, and the intake manifold 425 connected to the fifth cylinder 415. Also, the connecting pipe portion 432 connects the intake manifold 422 connected to the second cylinder 412, the intake manifold 424 connected to the fourth cylinder 414, and the intake manifold 426 connected to the sixth cylinder 416. That is, the connecting pipe portion 431 connects the intake manifolds that are connected to the corresponding cylinders in the bank block 42, and the connecting pipe portion 432 connects the intake manifolds that are connected to the corresponding cylinders in the bank block 43.

In the case of the V-six gasoline engine 40 as described above, mixed gas is ignited in the first cylinder 411, the second cylinder 412, the fifth cylinder 415, the sixth cylinder 416, the third cylinder 413, and the fourth cylinder 414 in this order. Thus, the connecting pipe portion 431 and the connecting pipe portion 432 connect the intake manifolds that are connected to the corresponding cylinders, in which mixed gas is ignited every other ignition timing.

By connecting the intake manifolds that are connected to the cylinders, in which mixed gas is ignited every other ignition timing, through the connecting pipe portion 431 and the connecting pipe portion 432, the variation of the flow of air is reduced in the intake manifolds connected by the connecting pipe portion 431 or the connecting pipe portion 432. The ignition interval between the cylinders, in which mixed gas is ignited every other ignition timing, is 120°, which is twice as large as 60°, that is, the ignition interval of the V-six gasoline engine 40.

When the reduction in pumping loss is prioritized, as shown in FIG. 4B, the connecting pipe portion 433 connects the intake manifold 421 connected to the first cylinder 411 and the intake manifold 426 connected to the sixth cylinder 416. The connecting pipe portion 434 connects the intake manifold 422 connected to the second cylinder 412 and the intake manifold 423 connected to the third cylinder 413. The connecting pipe portion 435 connects the intake manifold 424 connected to the fourth cylinder 414 and the intake manifold 425 connected to the fifth cylinder 415. The ignition interval, that is, the phase difference in the ignition timing between the first cylinder 411 and the sixth cylinder 416, between the second cylinder 412 and the third cylinder 413, and between the fourth cylinder 414 and the fifth cylinder 415, is 180°. Therefore, the phase difference in the ignition timing is 180°, which is three times as large as 60°, that is, the ignition interval of the V-six gasoline engine 40.

By connecting the intake manifolds that are connected to the cylinders, between which the phase difference in the ignition timing is 180°, through the connecting pipe portions 433, 434, 435, air is supplied through the connecting pipe portions 433, 434, 435 from the intake manifold connected to one cylinder before the inlet valve of the other cylinder opens. Accordingly, a pressure in the intake manifold increases to around the atmospheric pressure before the inlet valve opens. As a result, pumping loss is reduced.

### Fourth Embodiment

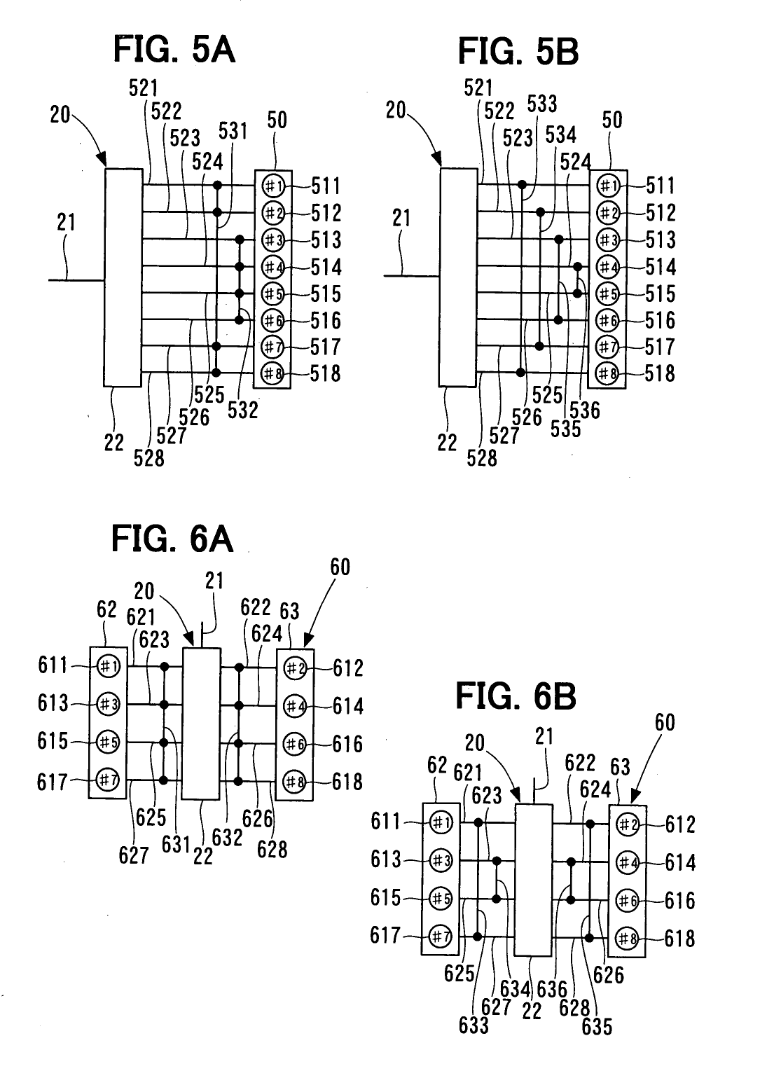

FIGS. 5A, 5B show a gasoline engine, in which an air-intake apparatus according to a fourth embodiment of the present invention is employed. A gasoline engine 50 shown in FIGS. 5A, 5B is a serially-arranged eight-cylinder gasoline engine. The serially-arranged eight-cylinder gasoline engine 50 has eight cylinders, that is, a first cylinder 511, a second cylinder 512, a third cylinder 513, a fourth cylinder 514, a fifth cylinder 515, a sixth cylinder 516, a seventh cylinder 517, and an eighth cylinder 518 in this order from before backward in a traveling direction of a vehicle. Intake manifolds 521, 522, 523, 524, 525, 526, 527, 528 corresponding to each cylinder connect a surge tank 22 and the gasoline engine 50. In the case of the serially-arranged eight-cylinder gasoline engine 50, mixed gas is combusted in, that is, mixed gas is ignited in the first cylinder 511, the fifth cylinder 515, the second cylinder 512, the sixth cylinder 516, the eighth cylinder 518, the fourth cylinder 514, the seventh cylinder 517, and the third cylinder 513 in this order. A combustion interval, that is, an ignition interval between the eight cylinders is 45°.

In the case of the above serially-arranged eight-cylinder gasoline engine 50, similar to the serially-arranged six-cylinder gasoline engine 30 of the second embodiment, one of the reduction in pumping loss and the reduction in the variation of the flow of air is prioritized over the other according to a manner in which connecting pipe portions 531, 532, 533, 534, 535, 536 are connected.

When the reduction in the variation of the flow of air is prioritized, as shown in FIG. 5A, the connecting pipe portion 531 connects the intake manifold 521 connected to the first cylinder 511, the intake manifold 522 connected to the second cylinder 512, the intake manifold 527 connected to the seventh cylinder 517, and the intake manifold 528 connected to the eighth cylinder 518. The connecting pipe portion 532 connects the intake manifold 523 connected to the third cylinder 513, the intake manifold 524 connected to the fourth cylinder 514, the intake manifold 525 connected to the fifth cylinder 515, and the intake manifold 526 connected to the sixth cylinder 516.

In the case of the serially-arranged eight-cylinder gasoline engine 50 as described above, mixed gas is ignited in the first cylinder 511, the fifth cylinder 515, the second cylinder 512, the sixth cylinder 516, the eighth cylinder 518, the fourth cylinder 514, the seventh cylinder 517, and the third cylinder 513 in this order. Thus, the connecting pipe portion 531 and the connecting pipe portion 532 connect the intake manifolds that are connected to the corresponding cylinders, in which mixed gas is ignited every other ignition timing.

By connecting the intake manifolds that are connected to the cylinders, in which mixed gas is ignited every other ignition timing, through the connecting pipe portion 531 and the connecting pipe portion 532, the variation of the flow of air is reduced in the intake manifolds connected by the connecting pipe portion 531 or the connecting pipe portion 532. The ignition interval between the cylinders, in which mixed gas is ignited every other ignition timing, is 90°, which is twice as large as 45°, that is, the ignition interval of the serially-arranged eight-cylinder gasoline engine 50.

When the reduction in pumping loss is prioritized, as shown in FIG. 5B, the connecting pipe portion 533 connects the intake manifold 521 connected to the first cylinder 511 and the intake manifold 528 connected to the eighth cylinder 518. The connecting pipe portion 534 connects the intake manifold 522 connected to the second cylinder 512 and the intake manifold 527 connected to the seventh cylinder 517. The connecting pipe portion 535 connects the intake manifold 523 connected to the third cylinder 513 and the intake manifold 526 connected to the sixth cylinder 516. The connecting pipe portion 536 connects the intake manifold 524 connected to the fourth cylinder 514 and the intake manifold 525 connected to the fifth cylinder 515. The ignition interval, that is, the phase difference in the ignition timing between the first cylinder 511 and the eighth cylinder 518, between the second cylinder 512 and the seventh cylinder 517, between the third cylinder 513 and the sixth cylinder 516, and between the fourth cylinder 514 and the fifth cylinder 515, is 180°. Therefore, the phase difference in the ignition timing is 180°, which is four times as large as 45°, that is, the ignition interval of the serially-arranged eight-cylinder gasoline engine 50.

By connecting the intake manifolds that are connected to the cylinders, between which the phase difference in the ignition timing is 180°, through the connecting pipe portions 533, 534, 535, 536, air is supplied through the connecting pipe portions 533, 534, 535, 536 from the intake manifold connected to one cylinder before the inlet valve of the other cylinder opens. Accordingly, a pressure in the intake manifold increases to around the atmospheric pressure before the inlet valve opens. As a result, pumping loss is reduced.

### Fifth Embodiment

FIGS. 6A, 6B show a gasoline engine, in which an air-intake apparatus according to a fifth embodiment of the present invention is employed. A gasoline engine 60 shown in FIGS. 6A, 6B is a V-eight engine. The V-eight gasoline engine 60 has a bank block 62 and a bank block 63. The bank block 62 has four cylinders, that is, a first cylinder 611, a third cylinder 613, a fifth cylinder 615, and a seventh cylinder 617 in this order from before backward in a traveling direction of a vehicle. The bank block 63 has four cylinders, that is, a second cylinder 612, a fourth cylinder 614, a sixth cylinder 616, and an eighth cylinder 618 in this order from before backward in the traveling direction of the vehicle.

A surge tank 22 is deposed between the bank block 62 and the bank block 63 of the gasoline engine 60. The surge tank 22 may be disposed independently corresponding to the bank block 62 and the bank block 63. Intake manifolds 621, 622, 623, 624, 625, 626, 627, 628 connect the surge tank 22 and the bank block 62, and the surge tank 22 and the bank block 63 corresponding to each cylinder. In the case of the V-eight gasoline engine 60, mixed gas is combusted in, that is, mixed gas is ignited in the first cylinder 611, the second cylinder 612, the third cylinder 613, the fourth cylinder 614, the seventh cylinder 617, the eighth cylinder 618, the fifth cylinder 615, and the sixth cylinder 616 in this order. A combustion interval, that is, an ignition interval between the eight cylinders is 45°

In the case of the above V-eight gasoline engine 60, similar to the serially-arranged six-cylinder gasoline engine 30 of the second embodiment, one of the reduction in pumping loss and the reduction in the variation of the flow of air is prioritized over the other according to a manner in which connecting pipe portions 631, 632, 633, 634, 635, 636 are connected.

When the reduction in the variation of the flow of air is prioritized, as shown in FIG. 6A, the connecting pipe portion 631 connects the intake manifold 621 connected to the first cylinder 611, the intake manifold 623 connected to the third cylinder 613, the intake manifold 625 connected to the fifth cylinder 615, and the intake manifold 627 connected to the seventh cylinder 617. The connecting pipe portion 632 connects the intake manifold 622 connected to the second cylinder 612, the intake manifold 624 connected to the fourth cylinder 614, the intake manifold 626 connected to the sixth cylinder 616, and the intake manifold 628 connected to the eighth cylinder 618. That is, the connecting pipe portion 631 connects the intake manifolds connected to each cylinder in the bank block 62, and the connecting pipe portion 632 connects the intake manifolds connected to each cylinder in the bank block 63.

As described above, in the case of the V-eight gasoline engine 60, mixed gas is ignited in the first cylinder 611, the second cylinder 612, the third cylinder 613, the fourth cylinder 614, the seventh cylinder 617, the eighth cylinder 618, the fifth cylinder 615, and the sixth cylinder 616 in this order. Thus, the connecting pipe portion 631 and the connecting pipe portion 632 connect the intake manifolds that are connected to the cylinders, in which mixed gas is ignited every other ignition timing.

By connecting the intake manifolds that are connected to the cylinders, in which mixed gas is ignited every other ignition timing, through the connecting pipe portion 631 and the connecting pipe portion 632, the variation of the flow of air is reduced in the intake manifolds connected by the connecting pipe portion 631 or the connecting pipe portion 632. The ignition interval between the cylinders, in which mixed gas is ignited every other ignition timing, is 90°, which is twice as large as 45°, that is, the ignition interval of the V-eight gasoline engine 60.

When the reduction in pumping loss is prioritized, as shown in FIG. 6B, the connecting pipe portion 633 connects the intake manifold 621 connected to the first cylinder 611 and the intake manifold 627 connected to the seventh cylinder 617. The connecting pipe portion 634 connects the intake manifold 623 connected to the third cylinder 613 and the intake manifold 625 connected to the fifth cylinder 615. The connecting pipe portion 635 connects the intake manifold 622 connected to the second cylinder 612 and the intake manifold 628 connected to the eighth cylinder 618. The connecting pipe portion 636 connects the intake manifold 624 connected to the fourth cylinder 614 and the intake manifold 626 connected to the sixth cylinder 616. The ignition interval, that is, the phase difference in the ignition timing between the first cylinder 611 and the seventh cylinder 617, between the third cylinder 613 and the fifth cylinder 615, between the second cylinder 612 and the eighth cylinder 618, and between the fourth cylinder 614 and the sixth cylinder 616, is 180°. Therefore, the phase difference in the ignition timing is 180°, which is four times as large as 45°, that is, the ignition interval of the V-eight gasoline engine 60.

By connecting the intake manifolds that are connected to the cylinders, between which the phase difference in the ignition timing is 180°, through the connecting pipe portions 633, 634, 635, 636, air is supplied through the connecting pipe portions 633, 634, 635, 636 from the intake manifold connected to one cylinder before the inlet valve of the other cylinder opens. Accordingly, a pressure in the intake manifold increases to around the atmospheric pressure before the inlet valve opens. As a result, pumping loss is reduced.

### Sixth Embodiment

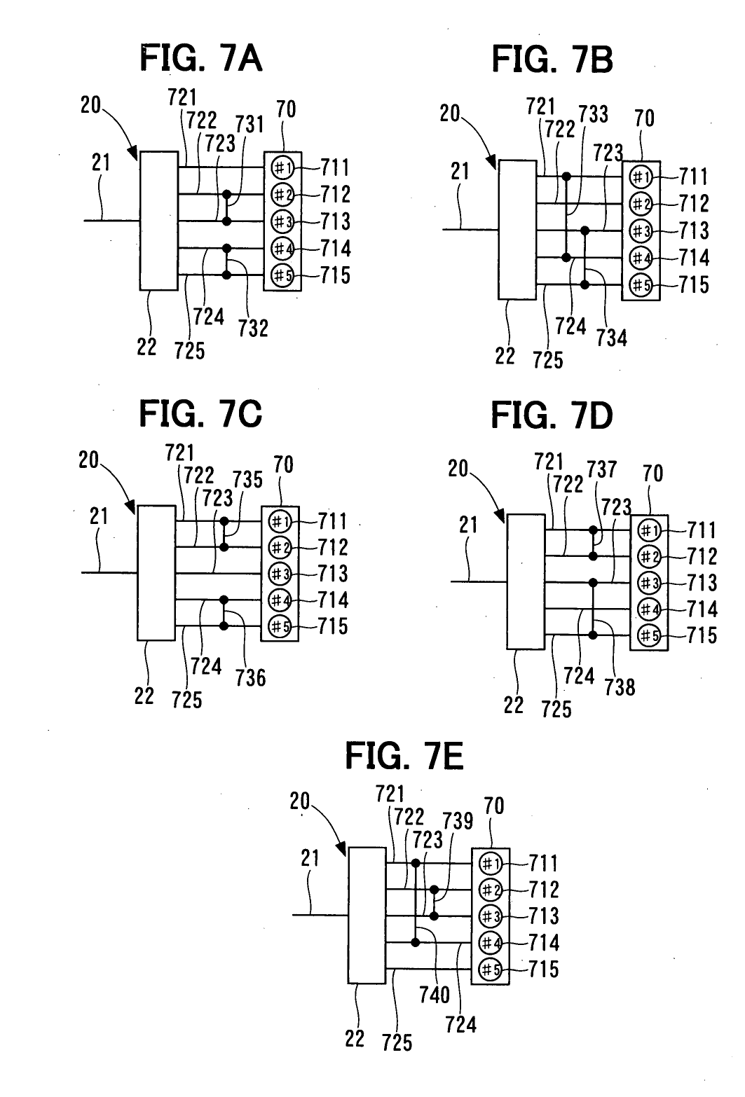

FIGS. 7A to 7E show a gasoline engine, in which an air-intake apparatus according to a sixth embodiment of the present invention is employed. A gasoline engine 70 shown in FIGS. 7A to 7E is a serially-arranged five-cylinder gasoline engine. The serially-arranged five-cylinder gasoline engine 70 has five cylinders, that is, a first cylinder 711, a second cylinder 712, a third cylinder 713, a fourth cylinder 714, and a fifth cylinder 715 in this order from before backward in a traveling direction of a vehicle. Intake manifolds 721, 722, 723, 724, 725 corresponding to each cylinder connect a surge tank 22 and the gasoline engine 70. In the case of the serially-arranged five-cylinder gasoline engine 70, mixed gas is combusted in, that is, mixed gas is ignited in the first cylinder 711, the fifth cylinder 715, the second cylinder 712, the fourth cylinder 714, and the third cylinder 713 in this order. A combustion interval, that is, an ignition interval between the five cylinders is 72°.

In the case of the above serially-arranged five-cylinder gasoline engine 70, there is an odd number of intake manifolds. Accordingly, one of the intake manifolds is not connected to any one of the other intake manifolds.

As shown in FIG. 7A, a connecting pipe portion 731 connects the intake manifold 722 connected to the second cylinder 712 and the intake manifold 723 connected to the third cylinder 713. A connecting pipe portion 732 connects the intake manifold 724 connected to the fourth cylinder 714 and the intake manifold 725 connected to the fifth cylinder 715.

In the case of the five-cylinder gasoline engine 70, mixed gas is ignited in the first cylinder 711, the fifth cylinder 715, the second cylinder 712, the fourth cylinder 714, and the third cylinder 713 in this order. Consequently, when mixed gas is ignited in the third cylinder 713 after in the second cylinder 712, mixed gas is ignited every other ignition timing with the ignition of the fourth cylinder 714 between the second cylinder 712 and the third cylinder 713, and when mixed gas is ignited in the second cylinder 712 after in the third cylinder 713, mixed gas is ignited every three ignition timings with the ignition of the first cylinder 711 and the fifth cylinder 715 between the third cylinder 713 and the second cylinder 712. As well, when mixed gas is ignited in the fourth cylinder 714 after in the fifth cylinder 715, mixed gas is ignited every other ignition timing, and when mixed gas is ignited in the fifth cylinder 715 after in the fourth cylinder 714, mixed gas is ignited every three ignition timings. As a result, the ignition interval is 216°, which is three times as large as 72° when mixed gas is ignited every three ignition timings, and the ignition interval is 144°, which is twice as large as 72° when mixed gas is ignited every other ignition timing.

Thus, as shown in FIG. 7A, when the intake manifolds are connected through the connecting pipe portion 731 and the connecting pipe portion 732, the reduction in pumping loss is given priority when mixed gas is ignited every three ignition timings, and the reduction in the variation of the flow of air is given priority when mixed gas is ignited every other ignition timing. In addition, the intake manifold 721, which is not connected to the connecting pipe portion 731 or the connecting pipe portion 732, is not affected by the intake manifolds connected to the other cylinders. Accordingly, pumping loss is reduced.

As shown in FIG. 7B, a connecting pipe portion 733 connects the intake manifold 721 connected to the first cylinder 711 and the intake manifold 724 connected to the fourth cylinder 714. A connecting pipe portion 734 connects the intake manifold 723 connected to the third cylinder 713 and the intake manifold 725 connected to the fifth cylinder 715. When mixed gas is ignited in the fourth cylinder 714 after in the first cylinder 711, mixed gas is ignited every three ignition timings with the ignition of the fifth cylinder 715 and the second cylinder 712 between the first cylinder 711 and the fourth cylinder 714, and when mixed gas is ignited in the first cylinder 711 after in the fourth cylinder 714, mixed gas is ignited every other ignition timing with the ignition of the third cylinder 713 between the fourth cylinder 714 and the first cylinder 711. As well, when mixed gas is ignited in the third cylinder 713 after in the fifth cylinder 715, mixed gas is ignited every three ignition timings, and when mixed gas is ignited in the fifth cylinder 715 after in the third cylinder 713, mixed gas is ignited every other ignition timing. As a result, the ignition interval is 216°, which is three times as large as 72° when mixed gas is ignited every three ignition timings, and the ignition interval is 144°, which is twice as large as 72° when mixed gas is ignited every other ignition timing.

Thus, as shown in FIG. 7B, when the intake manifolds are connected through the connecting pipe portion 733 and the connecting pipe portion 734, the reduction in pumping loss is given priority when mixed gas is ignited every three ignition timings, and the reduction in the variation of the flow of air is given priority when mixed gas is ignited every other ignition timing. In addition, the intake manifold 722, which is not connected to the connecting pipe portion 733 or the connecting pipe portion 734, is not affected by the intake manifolds connected to the other cylinders. Accordingly, pumping loss is reduced.

As shown in FIG. 7C, a connecting pipe portion 735 connects the intake manifold 721 connected to the first cylinder 711 and the intake manifold 722 connected to the second cylinder 712. A connecting pipe portion 736 connects the intake manifold 724 connected to the fourth cylinder 714 and the intake manifold 725 connected to the fifth cylinder 715. When mixed gas is ignited in the second cylinder 712 after in the first cylinder 711, mixed gas is ignited every other ignition timing with the ignition of the fifth cylinder 715 between the first cylinder 711 and the second cylinder 712, and when mixed gas is ignited in the first cylinder 711 after in the second cylinder 712, mixed gas is ignited every three ignition timings with the ignition of the fourth cylinder 714 and the third cylinder 713 between the second cylinder 712 and the first cylinder 711. As well, when mixed gas is ignited in the fourth cylinder 714 after in the fifth cylinder 715, mixed gas is ignited every other ignition timing, and when mixed gas is ignited in the fifth cylinder 715 after in the fourth cylinder 714, mixed gas is ignited every three ignition timings. As a result, the ignition interval is 216°, which is three times as large as 72° when mixed gas is ignited every three ignition timings, and the ignition interval is 144°, which is twice as large as 72° when mixed gas is ignited every other ignition timing.

Thus, as shown in FIG. 7C, when the intake manifolds are connected through the connecting pipe portion 735 and the connecting pipe portion 736, the reduction in pumping loss is given priority when mixed gas is ignited every three ignition timings, and the reduction in the variation of the flow of air is given priority when mixed gas is ignited every other ignition timing. In addition, the intake manifold 723, which is not connected to the connecting pipe portion 735 or the connecting pipe portion 736, is not affected by the intake manifolds connected to the other cylinders. Accordingly, pumping loss is reduced.

As shown in FIG. 7D, a connecting pipe portion 737 connects the intake manifold 721 connected to the first cylinder 711 and the intake manifold 722 connected to the second cylinder 712. A connecting pipe portion 738 connects the intake manifold 723 connected to the third cylinder 713 and the intake manifold 725 connected to the fifth cylinder 715. When mixed gas is ignited in the second cylinder 712 after in the first cylinder 711, mixed gas is ignited every other ignition timing with the ignition of the fifth cylinder 715 between the first cylinder 711 and the second cylinder 712, and when mixed gas is ignited in the first cylinder 711 after in the second cylinder 712, mixed gas is ignited every three ignition timings with the ignition of the fourth cylinder 714 and the third cylinder 713 between the second cylinder 712 and the first cylinder 711. As well, when mixed gas is ignited in the third cylinder 713 after in the fifth cylinder 715, mixed gas is ignited every three ignition timings, and when mixed gas is ignited in the fifth cylinder 715 after in the third cylinder 713, mixed gas is ignited every other ignition timing. As a result, the ignition interval is 216°, which is three times as large as 72° when mixed gas is ignited every three ignition timings, and the ignition interval is 144°, which is twice as large as 72° when mixed gas is ignited every other ignition timing.

As shown in FIG. 7D, when the intake manifolds are connected through the connecting pipe portion 737 and the connecting pipe portion 738, the reduction in pumping loss is given priority when mixed gas is ignited every three ignition timings, and the reduction in the variation of the flow of air is given priority when mixed gas is ignited every other ignition timing. In addition, the intake manifold 724, which is not connected to the connecting pipe portion 737 or the connecting pipe portion 738, is not affected by the intake manifolds connected to the other cylinders. Accordingly, pumping loss is reduced.

As shown in FIG. 7E, a connecting pipe portion 740 connects the intake manifold 721 connected to the first cylinder 711 and the intake manifold 724 connected to the fourth cylinder 714. A connecting pipe portion 739 connects the intake manifold 722 connected to the second cylinder 712 and the intake manifold 723 connected to the third cylinder 713. When mixed gas is ignited in the fourth cylinder 714 after in the first cylinder 711, mixed gas is ignited every three ignition timings with the ignition of the fifth cylinder 715 and the second cylinder 712 between the first cylinder 711 and the fourth cylinder 714, and when mixed gas is ignited in the first cylinder 711 after in the fourth cylinder 714, mixed gas is ignited every other ignition timing with the ignition of the third cylinder 713 between the fourth cylinder 714 and the first cylinder 711. As well, when mixed gas is ignited in the third cylinder 713 after in the second cylinder 712, mixed gas is ignited every other ignition timing, and when mixed gas is ignited in the second cylinder 712 after in the third cylinder 713, mixed gas is ignited every three ignition timings. As a result, the ignition interval is 216°, which is three times as large as 72° when mixed gas is ignited every three ignition timings, and the ignition interval is 144°, which is twice as large as 72° when mixed gas is ignited every other ignition timing.

As shown in FIG. 7E, when the intake manifolds are connected through the connecting pipe portion 739 and the connecting pipe portion 740, the reduction in pumping loss is given priority when mixed gas is ignited every three ignition timings, and the reduction in the variation of the flow of air is given priority when mixed gas is ignited every other ignition timing. In addition, the intake manifold 725, which is not connected to the connecting pipe portion 739 or the connecting pipe portion 740, is not affected by the intake manifolds connected to the other cylinders. Accordingly, pumping loss is reduced.

### Seventh Embodiment

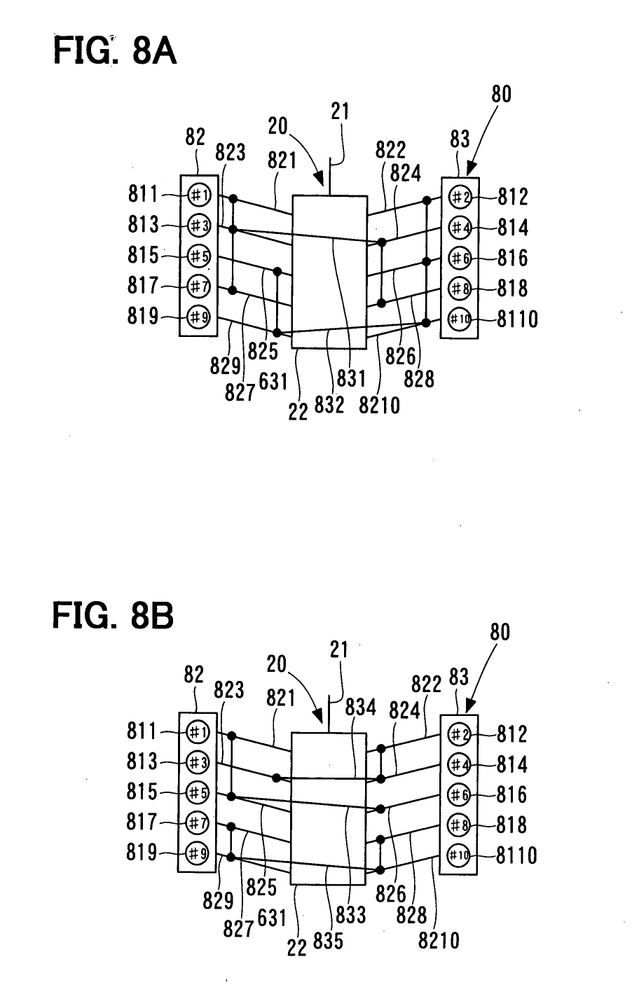

FIGS. 8A, 8B show a gasoline engine, in which an air-intake apparatus according to a seventh embodiment of the present invention is employed. A gasoline engine 80 shown in FIGS. 8A, 8B is a V-ten engine. The V-ten gasoline engine 80 has a bank block 82 and a bank block 83. The bank block 82 has five cylinders, that is, a first cylinder 811, a third cylinder 813, a fifth cylinder 815, a seventh cylinder 817, and a ninth cylinder 819 in this order from before backward in a traveling direction of a vehicle. The bank block 83 has five cylinders, that is, a second cylinder 812, a fourth cylinder 814, a sixth cylinder 816, an eighth cylinder 818, and a tenth cylinder 8110 in this order from before backward in the traveling direction of the vehicle.

A surge tank 22 is deposed between the bank block 82 and the bank block 83 of the gasoline engine 80. The surge tank 22 may be disposed independently corresponding to the bank block 82 and the bank block 83. Intake manifolds 821, 822, 823, 824, 825, 826, 827, 828, 829, 8210 connect the surge tank 22 and the bank block 82, and the surge tank 22 and the bank block 83 corresponding to each cylinder. In the case of the V-ten gasoline engine 80, mixed gas is combusted, that is, mixed gas is ignited in, for example, the first cylinder 811, the tenth cylinder 8110/the ninth cylinder 819, the fourth cylinder 814/the third cylinder 813, the sixth cylinder 816/the fifth cylinder 815, the eighth cylinder 818/the seventh cylinder 817, and the second cylinder 812 in this order. In the above example, a combustion interval, namely an ignition interval is unequal, that is, the ignition interval is 54° except that the ignition interval is 90° between the second cylinder 812 and the first cylinder 811 in this order (i.e., between the cycles).

In the case of the above V-ten gasoline engine 80, similar to the serially-arranged six-cylinder gasoline engine 30 of the second embodiment, one of the reduction in pumping loss and the reduction in the variation of the flow of air is prioritized over the other according to a manner in which connecting pipe portions 831, 832, 833, 834, 835 are connected.

When the reduction in the variation of the flow of air is prioritized, as shown in FIG. 8A, the connecting pipe portion 831 connects the intake manifold 821 connected to the first cylinder 811, the intake manifold 823 connected to the third cylinder 813, the intake manifold 827 connected to the seventh cylinder 817, the intake manifold 824 connected to the fourth cylinder 814, and the intake manifold 828 connected to the eighth cylinder 818. The connecting pipe portion 832 connects the intake manifold 825 connected to the fifth cylinder 815, the intake manifold 829 connected to the ninth cylinder 819, the intake manifold 822 connected to the second cylinder 812, the intake manifold 826 connected to the sixth cylinder 816, and the intake manifold 8210 connected to the tenth cylinder 8110.

As described above, in the case of the V-ten gasoline engine 80, mixed gas is ignited in, for example, the first cylinder 811, the tenth cylinder 8110/the ninth cylinder 819, the fourth cylinder 814/the third cylinder 813, the sixth cylinder 816/the fifth cylinder 815, the eighth cylinder 818/the seventh cylinder 817, and the second cylinder 812 in this order. Thus, the connecting pipe portion 831 and the connecting pipe portion 832 connect the intake manifolds that are connected to the cylinders, in which mixed gas is ignited every other ignition timing.

By connecting the intake manifolds that are connected to the cylinders, in which mixed gas is ignited every other ignition timing, through the connecting pipe portion 831 and the connecting pipe portion 832, the variation of the flow of air is reduced in the intake manifolds connected by the connecting pipe portion 831 or the connecting pipe portion 832.

When the reduction in pumping loss is prioritized, as shown in FIG. 8B, the connecting pipe portion 833 connects the intake manifold 821 connected to the first cylinder 811, the intake manifold 825 connected to the fifth cylinder 815, and the intake manifold 826 connected to the sixth cylinder 816. The connecting pipe portion 834 connects the intake manifold 822 connected to the second cylinder 812, the intake manifold 823 connected to the third cylinder 813, and the intake manifold 824 connected to the fourth cylinder 814. Furthermore, the connecting pipe portion 835 connects the intake manifold 827 connected to the seventh cylinder 817, the intake manifold 828 connected to the eighth cylinder 818, the intake manifold 829 connected to the ninth cylinder 819, and the intake manifold 8210 connected to the tenth cylinder 8110.

In this manner, the intake manifolds that are connected to the cylinders, between which the phase difference in the ignition timing is equal to or larger than 1800, are connected through the connecting pipe portions 833, 834, 835. Consequently, before the inlet valve of one cylinder opens, air is supplied through the connecting pipe portions 833, 834, 835 from the intake manifolds connected to the other cylinders. Accordingly, a pressure in the intake manifold increases to around the atmospheric pressure before the inlet valve opens. As a result, pumping loss is reduced.

### Other Embodiments

In the embodiments described above, the arrangement of cylinders of relatively common gasoline engines is considered for example. However, the present invention may be applied not only to the arrangement of cylinders of the gasoline engines described in the above embodiments, but to another arrangement of cylinders. As well, in the seventh embodiment, although the unequal ignition interval 54°/90° in the V-ten gasoline engine 80 is taken for example, the invention may be applied to an equal ignition interval.

Furthermore, in the above embodiments, an air-intake apparatus is applied to a gasoline engine. However, the air-intake apparatus of the present invention may be applied to a Diesel engine as well as the gasoline engine. In the case of the Diesel engine, a firing timing may be applied instead of the ignition timing.

The present invention is not by any means limited to the above embodiments, and it may be applied to various embodiments without departing from the scope of the invention.

What is claimed is:

1. An air-intake apparatus for an internal combustion engine having a plurality of cylinders, comprising:
a surge tank;
a plurality of intake manifolds, each of which connects the surge tank and corresponding one of the plurality of cylinders, wherein:
the plurality of cylinders includes a predetermined group of cylinders, a phase difference in combustion timing between which is an integral multiple of a combustion interval between the plurality of cylinders of the internal combustion engine;
the integral multiple is equal to or larger than two times; and
the plurality of intake manifolds includes a group of intake manifolds, each of which is connected to corresponding one of the predetermined group of cylinders;
a throttle that includes a plurality of valve members, each of which is disposed in corresponding one of the plurality of intake manifolds to open or close an air flowing passage in the corresponding one of the plurality of intake manifolds; and
a connecting pipe portion that is located between the internal combustion engine and the throttle, wherein the connecting pipe portion connects the group of intake manifolds.

2. The air-intake apparatus according to claim 1, wherein among the predetermined group of cylinders, mixed gas is combusted every other combustion timing of the internal combustion engine.

3. The air-intake apparatus according to claim 1, wherein the phase difference in combustion timing between the predetermined group of cylinders is equal to or larger than 180°.
